(19) United States
(12) Patent Application Publication
(10) Pub. No.: US 2017/0347396 A1
(43) Pub. Date: Nov. 30, 2017

(54) TEMPERATURE MANIPULATING APPARATUS AND METHOD OF PREPARATION THEREOF

(71) Applicant: Advanced Materials Enterprises Co., Ltd, Hong Kong (HK)

(72) Inventors: Wing Yiu Yeung, Hong Kong (HK); Man Kit Chan, Hong Kong (HK); Ho Yin Chan, Hong Kong (HK)

(21) Appl. No.: 15/603,500

(22) Filed: May 24, 2017

Related U.S. Application Data
(60) Provisional application No. 62/340,532, filed on May 24, 2016.

(51) Int. Cl. H05B 1/02; H05B 3/16; H05B 3/14; H05B 3/20; H05B 3/03

(52) U.S. Cl. CPC H05B 1/0236; H05B 3/20; H05B 3/03; H05B 3/145; H05B 3/16

(57) ABSTRACT

A temperature manipulating apparatus for providing heating to different components of a vehicle, which includes a base medium made of rigid or flexible materials, such as glass, ceramic, plastic sheet, a fabric sheet and a leather sheet. The temperature manipulating apparatus includes a plurality of heat generating elements which are connected to the plurality of electricity conducting electrodes. The temperature manipulating apparatus includes a plurality of electricity conducting electrodes which are disposed on the heat generating elements and the base medium. The temperature manipulating apparatus may be supplied electricity from an electric power source via a connecting module. The plurality of heat generating elements may be in form of one or more layers of electrically conductive elements disposed on the base medium. The heat generating elements may be arranged in various configurations with respect to the electricity conducting electrodes to maximize the heating effect and suit different shapes of different components to be applied with the temperature manipulating apparatus.

### CROSS-REFERENCE TO RELATED APPLICATIONS AND PRIORITY

The present application claims priority from U.S. Application No. 62/340,532 filed on May 24, 2016.

### TECHNICAL FIELD OF THE INVENTION

The present patent application pertains generally to temperature manipulation apparatus, and specifically to heat generation systems for various components of vehicles.

### BACKGROUND

There may be various components in vehicles (automobiles) which may require heating to a certain temperature for optimal working of the components. An example of such a component may be the electricity storage device, such as a battery. Other examples may include the rear-view mirrors, door handles, windows, windscreen and steering wheel.

In cold climatic conditions, the temperature of battery(ies) of vehicles may fall below a required running temperature. As a result, the performance of the battery(ies) may suffer leading to improper working, quicker degradation, and in some cases failure of the battery(ies). For optimal performance of the battery(ies), it may therefore become necessary to have the battery(ies) maintained at a certain minimum temperature.

Also, icing may get formed on a vehicle's windshield, outer rear view mirrors, or side window glasses due to cold temperatures. This makes driving difficult and dangerous for the driver. The existing solutions include heating coils to increase the temperature of these parts in order to de-ice. However, these solutions are slow and inefficient.

Further, cold temperatures also make steering wheel difficult to hold and vehicle seats uncomfortable to sit.

Therefore, it is desired to provide a temperature manipulating apparatus to provide heating to the different components of a vehicle so as to raise and maintain optimum temperature for comfortable operation.

### SUMMARY

The present subject matter describes a temperature manipulating apparatus. The temperature manipulating apparatus may be powered by an electrical power source. Further, the power from the electrical power source may be supplied to the temperature manipulating apparatus via a connecting module. The temperature manipulating apparatus further includes a base medium, a plurality of heat generating elements disposed on the base medium and a plurality of electricity conducting electrodes disposed on the heat generating elements which are connected to the plurality of electricity conducting electrodes. The connecting module is adapted to connect the electrical power source with the temperature manipulating apparatus.

The present subject matter further describes a method of making a temperature manipulating apparatus. The method includes providing a base medium, disposing a plurality of heat generating elements on the base medium, and forming a plurality of electrically conducting electrodes on the heat generating elements and the base medium wherein the heat generating elements are connected to the electrically conducting electrodes to receive power supply to generate heat energy.

The present application also provides a temperature manipulating apparatus including;

a base medium;
a plurality of heat generating elements, wherein the plurality of heat generating elements are disposed on the base medium, wherein further the heat generating elements comprises embedded metallic or carbon-based nano-particles, nano-tubes or nano-wires having diameter of less than 100 nm;
a plurality of electricity conducting electrodes, wherein the plurality of electricity conducting electrodes are disposed on the heat generating elements and the base medium, wherein the plurality of electricity conducting electrodes are configured to receive electricity from an electrical power source;
wherein further, the plurality of heat generating elements are connected to the plurality of electricity conducting electrodes to receive electricity, wherein upon receiving electricity, the plurality of heat generating elements generate heat.

The temperature manipulating apparatus as above, wherein the base medium is rigid, or flexible.

The temperature manipulating apparatus as above, wherein the flexible base made from materials selected from a plastic, a fabric, a leather sheet, a transparent film and a single sided glue tape.

The temperature manipulating apparatus as above, wherein the heat generating elements are made from source materials selected from a group comprising a tin, indium, cadmium, vanadium, silver and carbon.

The temperature manipulating apparatus as above, wherein the heat generating elements comprise of precursors selected from a group comprising a Monobutyl Tin Tri-chloride, N-Methyl-2-pyrrolidone, Dimethylacetamide, or Dimethylformamide.

The temperature manipulating apparatus as above, wherein the plurality of electricity conducting electrodes are positioned parallel to each other.

The temperature manipulating apparatus as above, wherein the plurality of electricity conducting electrodes are positioned inclined to each other.

The temperature manipulating apparatus as above, wherein the plurality of heat generating elements are in shape of strips.

The temperature manipulating apparatus as above, wherein the strips are positioned perpendicular to the plurality of electricity conducting electrodes.

The temperature manipulating apparatus as above, wherein the strips are positioned at an angle to the electricity conducting electrodes, wherein the angles ranges from 0 degrees to 90 degrees.

The temperature manipulating apparatus as above, wherein the strips are of equal length and width, or unequal length and width.

The temperature manipulating apparatus as above, wherein the strips are curved.

The temperature manipulating apparatus as above, wherein the curvature of the strips is equal, or variable.

The temperature manipulating apparatus as above, wherein the electrical power source is selected from an A.C. power source, a D.C. power source and a combination of an A.C. power source and a D.C. power source.

The temperature manipulating apparatus as above, comprises a plurality of non-heat generating interspaces in between the plurality of heat generating elements.

The temperature manipulating apparatus as above, wherein width of the plurality of heat generating elements and the plurality of non-heat generating interspaces is in ratio of between 1:1 and 3:1.

The temperature manipulating apparatus as above, wherein the plurality of heat generating elements are positioned on the base medium by a printing process, or a lamination process.

The present application also provides a method of making a heat manipulating apparatus including the steps of;

providing a base medium;
positioning a plurality of heat generating elements on the base medium;
positioning a plurality of electricity conducting electrodes on the heat generating elements, wherein the heat generating elements are connected to the electricity conducting electrodes.

The method of making a heat manipulating apparatus as above, further includes applying a multi-layered insulating coating with layers of a nano-thickness of less than 100 nm on the base medium.

### BRIEF DESCRIPTION OF THE DRAWINGS

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

FIG. 1 shows a perspective view of a battery warming system with a temperature manipulating apparatus, as one embodiment of the subject matter.

FIG. 2 shows a cross-sectional view along the section A-A of the battery warming system with a temperature manipulating apparatus, as another embodiment of the subject matter.

FIG. 3 shows another cross-sectional along the section B-B of battery warming system with a temperature manipulating apparatus, as another embodiment of the subject matter.

FIG. 4 shows an embodiment of temperature manipulating apparatus, as one embodiment of the subject matter.

FIG. 5 shows a graphical representation of the characteristics of the temperature manipulating apparatus, as one embodiment of the subject matter.

FIG. 6 shows a perspective view of a battery warming system with a temperature manipulating apparatus with alternative configuration of air passage, as another embodiment of the subject matter.

FIG. 7 shows the cross-sectional view along the section C-C of the battery warming system with a temperature manipulating apparatus with alternative configuration of air passage, as an embodiment of the subject matter.

FIG. 8 shows a perspective view of the battery warming system with a temperature manipulating apparatus within alternative configuration of air passage constructed with flexible plastic channel tubing, as an embodiment of the subject matter.

FIG. 9 shows a cross-sectional view along the section D-D of the battery warming system with a temperature manipulating apparatus within an alternative configuration of air passage constructed with flexible plastic channel tubing, as an embodiment of the subject matter.

FIG. 10 shows a perspective view of the battery warming system with the temperature manipulating apparatus in direct contact with the walls of the battery, as an embodiment of the subject matter.

FIG. 11 shows a perspective view of the configuration of battery warming system with a temperature manipulating apparatus, as another embodiment of the subject matter.

FIG. 12 shows a perspective view of a vehicle side rear view mirror with a temperature manipulating apparatus attached on the front side of the vehicle side rear view mirror, as another embodiment of the subject matter.

FIG. 13 shows a perspective view of a vehicle side rear view mirror with a temperature manipulating apparatus attached on the back side of the vehicle side rear view mirror, as another embodiment of the subject matter.

FIG. 14 shows a perspective view of a temperature manipulating apparatus for a vehicle side rear view mirror, as another embodiment of the subject matter.

FIG. 15 shows a perspective view of a vehicle with heated side windows and windscreens utilized in a vehicle, as another embodiment of the subject matter.

FIG. 16 shows the temperature manipulating apparatus with the heating film covering the whole area of the heating member utilized on side windows and windscreens of vehicles, as another embodiment of the subject matter.

FIG. 17 shows a temperature manipulating apparatus with heating film formed in strips and separated by non-heating-film interspace connected with electricity conducting electrodes on the two edges utilized on side windows and windscreens of vehicles, as another embodiment of the subject matter.

FIG. 18 shows a perspective view of a vehicle with a heated door handle and door rim, as an embodiment of the subject matter.

FIG. 19 shows a heated steering wheel of a vehicle, as an embodiment of the subject matter.

FIG. 20 shows a temperature manipulating apparatus wrap of a heated steering wheel of a vehicle, as an embodiment of the subject matter.

FIG. 21 shows an embodiment of the temperature manipulating apparatus configuration, as an embodiment of the subject matter.

FIG. 22 shows the thermal image of the temperature distribution on the temperature manipulating apparatus, as an embodiment of the subject matter.

FIG. 23 shows a graphic representation of heating performance of a temperature manipulating apparatus at different power densities, as an embodiment of the subject matter.

FIG. 24 shows a graphical representation of cyclic testing results of a temperature manipulating apparatus, as an embodiment of the subject matter.

FIG. 25 shows another embodiment of temperature manipulating apparatus configuration with the heating film strips of various curvature and thickness, as an embodiment of the subject matter.

FIG. 26 shows a heated arm rest of a vehicle, as an embodiment of the subject matter.

FIG. 27 shows a cross-sectional view along the section E-E of a heated armrest with the temperature manipulating apparatus attached underneath the armrest, as an embodiment of the subject matter.

FIG. 28 shows a perspective view of a heated seat of a vehicle, as an embodiment of the subject matter.

FIG. 29 shows another embodiment of the temperature manipulating apparatus with the heating film configuration, as an embodiment of the subject matter.

FIG. 30 shows a heated door trim in a vehicle, as an embodiment of the subject matter.

FIG. 31 shows another embodiment of the temperature manipulating apparatus with the heating film strips of various curvature, length and thickness, as an embodiment of the subject matter.

FIG. 32 is a flow diagram, illustrating a method of making a temperature manipulating apparatus, as an embodiment of the subject matter.

### DETAILED DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

A temperature manipulating apparatus is described. The temperature manipulating apparatus may be electrically powered and may be employed to provide heating to various components of a vehicle. For example, the components of the automobile include a battery, side rear view mirrors, vehicle doors and steering wheel. However, the scope of the present subject matter may not be limited to the aforementioned components and may extend to other components and devices.

The electrical power sources may include power generating source or electricity storing sources. Further, the electrical power source may be Alternating Current (AC) source or a Direct Current (DC) source or a combination of the AC and DC sources.

It may be understood that if the temperature manipulating apparatus is DC compatible, and the available electrical power source is an AC electricity source, then the temperature manipulating apparatus may be supplied power by AC-DC adaptor. Further, the DC compatible temperature manipulating apparatus may be supplied power by various other sources, such as USB connector, plug-in vehicle battery, lithium battery, rechargeable battery, conventional battery, solar energy power pad or panel, and supercapacitor.

The temperature manipulating apparatus temperature manipulating apparatus may be adapted to produce the heating effect by converting electrical energy supplied by the electrical power source to heat energy.

In an implementation of the subject matter, the temperature manipulating apparatus includes a base medium. The base medium may be made of rigid materials selected from glass, ceramic and any other suitable materials. Further, the base medium may be made of a flexible material selected from fabric, leather, plastic and any other suitable flexible material. Furthermore, the shape and size of the base medium may vary depending upon the requirement.

The temperature manipulating apparatus may include electricity conducting electrodes, hereinafter referred to as electrodes, disposed on the heat generating elements and the base medium. The electrodes may carry the electric current supplied by the electrical power source. The electrodes may be disposed by a printing or a lamination process.

The temperature manipulating apparatus may further include a plurality of heat generating elements. The heat generating elements may be connected with the plurality of electrodes. Further, the heat generating elements may be adapted to use the electrical current supplied by the electrodes into perform heating.

The heat generating elements may be in form of one or more layers of a planar structure deposited, printed or laminated upon the base medium. Each of the one or more layers may have thickness in the range of a 70 nanometers (nm) to 500 nanometers (nm). Preferably, the thickness of each of the layers may be kept in the range of 100 nm to 300 nm when deposited on a base medium of ceramic glass or a flexible base medium made of plastic or fabrics or leather. The heat generating elements may be disposed in layers of a planar structure, such that the heat generating elements are spread all across the layers and are evenly spaced to ensure optimal matching between the electrodes and the layers and the substrate. The disposition of the heat generating elements with respect to the layers results in minimal electrical resistance and improved electrical and heat conductivity.

In an implementation of the subject matter, the heat generating elements are doped with suitable materials to improve the performance of the temperature manipulating. The heat generating elements may further include rigidity inducing materials to allow the layers to maintain a stable structure. Furthermore, the heat generating elements may be doped with suitable materials for improving conductivity of the layers to extremely low temperature and high temperatures.

In an implementation, a multi-layer insulating coating may be provided on the temperature manipulating apparatus. The multi-layer insulating coating may comprise sol-gel derived silicon dioxide.

Furthermore, surfactant layer may be deposited on the substrate. The surfactant may include perfluoralkyl surfactant of a concentration between about 0.01 and about 0.001% w/w with sodium dioctyl sulphosuccinate of a concentration between about 0.1 and about 0.01% w/w.

In one implementation of the present subject matter, the temperature manipulating apparatus includes and is powered by electricity supplied by a connecting module. The connecting module may be adapted to connect the electrical power source with the temperature manipulating apparatus. The connecting module may be in form of a connecting wire, or an adaptor.

Accordingly, the electricity supplied by the electrical source may be directed by the connecting module to the temperature manipulating apparatus, wherefrom the electricity may be supplied to the electrodes to be thereby converted by the heat generating elements into heat.

Further, if the temperature manipulating apparatus is DC compatible, and the available electrical power source is an AC electricity source, then the connecting module may include an AC-DC adaptor to convert the AC power into DC to supply it to the temperature manipulating apparatus. Further, the DC compatible temperature manipulating apparatus may be supplied power by connecting modules which may include USB connector, plug-in vehicle battery, lithium battery, rechargeable battery, conventional battery, solar energy power pad or panel, and supercapacitor.

During working of the temperature manipulating apparatus, the electrical source supplies electrical current to the electrodes of the temperature manipulating apparatus via the connecting module. The electric current may be received from the electrodes by the heat generating elements. As mentioned earlier, the heat generating elements may have the property to convert electrical current into physical heat. Therefore, as the electrical current passes through the heat generating elements, due to the property of the heat generating elements, heat energy is generated. This heat energy may then be utilized for providing heat to various components and perform a variety of heating or warming functions.

Further, the temperature manipulating apparatus may employ a temperature control system. The heat generated by and temperature of the heat generating elements may be controlled by the temperature control system. The temperature control system may further employ a temperature monitor for monitoring the temperature of the heat generating elements. Based on the required temperature of the heat generating elements, the temperature control system may then control electrical current supply to thereby control the temperature of the heat generating elements. Accordingly, the temperature control system may employ a control circuit or an energy capacity design of the heating member to maintain an optimal balance between the electrical current supply and the heat output from the heat generating elements.

The temperature control system may further employ various other systems for controlling the heat generation in the heat generating elements, in smoothing the power supply to the heat generating elements and optimizing the heating effect and energy efficiency. Examples of such systems include intelligent power and temperature monitor and control system, Analog-to-Digital Converter (ADC), Pulse-Width Modulation (PWM) drives and other temperature control devices. Further, a servo system may be provided for continuous monitoring and controlling with fast responses and in smoothing the power supply to the temperature manipulating apparatus and optimizing their heating performance and energy efficiency.

As mentioned before, the heat generating elements may be doped with suitable heat generating elements to lend desired properties to the heat generating elements. Further, the heat generating elements may be made from various metal based materials and carbon-based materials. The heat generating elements may further be embedded with metallic or carbon-based nano-particles, nano-tubes or nano-wires having diameter of less than 100 nm. The heat generating elements may be made from source materials selected from tin, indium, cadmium, vanadium, silver and carbon with precursors like Monobutyl Tin Tri-chloride, N-Methyl-2-pyrrolidone, Dimethylacetamide or Dimethylformamide. The nano-particles, nano-tubes or nano-wires may be made from sources selected from silver, carbon or other suitable materials.

The heat generating elements may be deposited on the base medium by way any of the various processes, such as spray process, printing process, roll-to-roll process and vacuum deposition process under controlled process parameters. The processes may be performed under controlled conditions of processing temperature and pressure while taking into consideration the quantity of materials applied and rate of deposition and reaction.

The temperature manipulating apparatus as described above may find applications in various fields. Some exemplary embodiments of the temperature manipulating apparatus are described below in accordance with the applications of the same.

### Exemplary Embodiments

### Vehicle Battery Warming System

One of the applications of the temperature manipulating apparatus as described in this patent application may be in a battery warming system.

It may be appreciated that lately there has been an upward trend of production of electric vehicles and hybrid electric vehicles in the automotive industry with an aim to reduce fossil fuel consumption, and overall carbon footprint and hence pollution to the environment. It may be understood that while electric vehicles can perform well under normal temperature conditions, however, the battery capacity may drop significantly at low temperatures operating environment. The low temperatures operating environment is known to adversely affect the performance of electric vehicles and hybrid electric vehicles. It is observed that the performance of batteries of electric vehicles may drop to 80% capacity at 10° C. and further below 70% capacity at low temperature of 1° C. To overcome the problems posed by the low temperatures operating environment, a battery heating or warming system is desired which may aid in maintaining the battery at an optimal working temperature.

A self-contained battery warming system is described in the present patent application. The battery warming system may be capable of fast heating and quick response to demand. Further, the desired battery warming system may be powered by DC power source, such as battery of the vehicle, although battery warming system may employ a separate low voltage DC power supply.

Further, it is desired that the battery warming system is compact and slim for space saving, has a large heating area so as to maximize heating effect, a high-power output and battery warming system, as per the requirement.

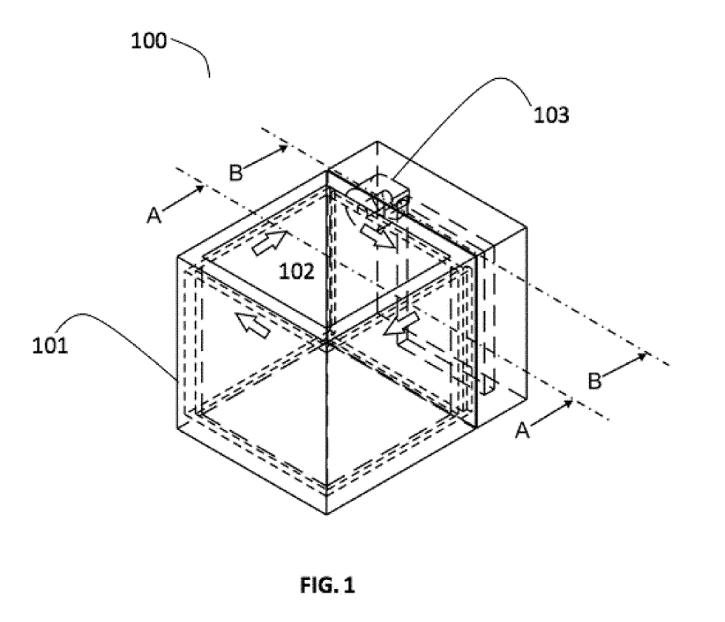

FIGS. 1-3 show different views of an embodiment of a battery warming system 100. FIG. 1 shows a battery warming system 100. The battery warming system 100 comprises multiple boundary walls 101 together forming a chamber 102. The battery warming system 100 further includes temperature manipulating apparatus, or a temperature manipulating apparatus (not shown in FIGS. 1-3), provided inside the chamber 102. The chamber 102 may further house the battery of the vehicle.

The temperature manipulating apparatus, hereinafter called temperature manipulating apparatus, may include a base medium of thin ceramic material. Further, temperature manipulating apparatus may include a film of heat generating element deposited over the substrate. The heat generating elements maybe made of material having reliable high temperature heating capacity and capable of performing in reliable and consistent function at heating temperatures up to 600° C. The temperature manipulating apparatus may further include electrodes disposed on the base medium and the heat generating element. The electrodes may carry the electric current supplied by the electrical power source.

As mentioned earlier, the heat generating elements may be in form of one or more layers deposited, printed or laminated upon the base medium. Each of these layers may have thickness in the range of a 70 nanometers (nm) to 500 nanometers (nm). Preferably, the thickness of each of the layers may be in the range of 100 nm to 300 nm. The heat generating elements may be disposed across the base medium, such that the heat generating elements evenly and densely spread all over the base medium to ensure optimal matching between the electrodes and the heat generating elements and the substrate. The disposition of the heat generating elements with respect to the base medium results in minimal electrical resistance and improved electrical and heat conductivity.

In an implementation of the subject matter, the heat generating elements may be doped with suitable materials to improve the performance of the temperature manipulating apparatus. The heat generating elements may further be embedded with rigidity-inducing materials for providing a stable structure. Furthermore, the heat generating elements may be doped with suitable materials for improving resistance of the layers to extremely low temperature and high temperatures.

Returning back to FIG. 1, the temperature manipulating apparatus (not shown in FIG. 1) may be positioned within the walls 101 of the chamber 102 of the battery warming system 100. Further, more than one temperature manipulating apparatuses of the same or different sizes and power ratings may be employed. The battery warming system 100 may further include an electric fan 103 which may be placed in the chamber adjacent to the temperature manipulating apparatus. The fan 103 may blow air heated due to heat generated by the temperature manipulating apparatus throughout the battery warming system 100 to provide heat to the battery. The fan 103 and the temperature manipulating apparatus may be placed at different positions of the battery warming system 100. Further, more than one fan 103 may be used to maximize the flow of the heated air as desired.

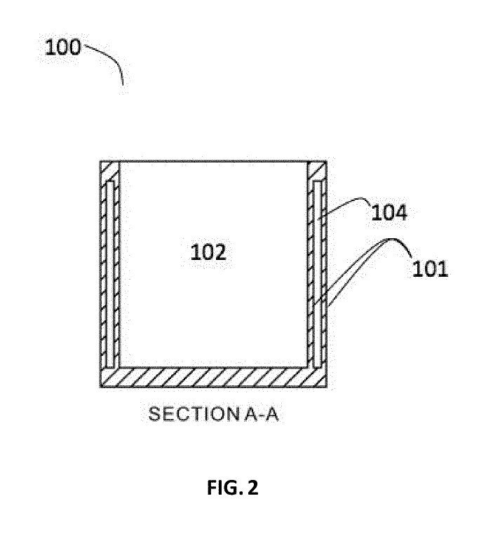

FIG. 2 shows a cross-sectional view of the battery warming system 100 along a section A-A. It can be seen that the walls 101 enclose a chamber 102 within which a battery may be positioned. The fan 103 may be positioned to circulate hot air within the battery warming system 100. The walls 101 may include hollow channels 104 to better circulate the hot air throughout the battery warming system 100. Further, the fan 103 and the temperature manipulating apparatus may be connected and driven by the battery of the electric vehicle or by a separate DC power source. In an embodiment of the battery warming system 100, the electric fan 103 may be driven by 24V DC power or at other electrical voltages with an output of 8 W or other wattages and the temperature manipulating apparatus may be driven by 24V DC power or at other electrical voltages with energy output of 80 W or other wattages.

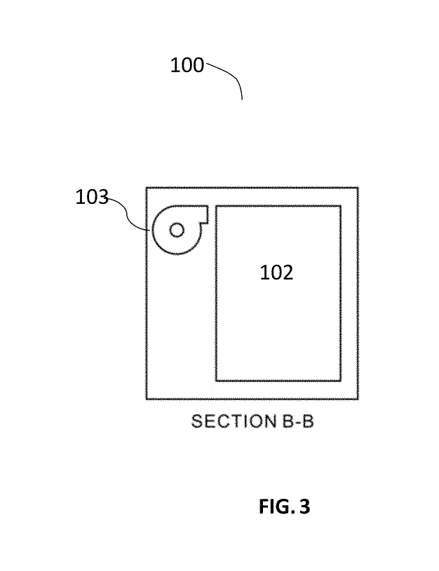

FIG. 3 shows a cross-sectional view of the battery warming system 100 along a section B-B. The battery warming system 100, as shown in FIG. 3, includes a chamber 102 and fan 103. The fan 103 may be positioned at any suitable position with respect to the chamber so as to provide efficient heat circulation to the battery inside the chamber 102.

During working of the battery warming system 100, electrical current is supplied by electrical source to electrodes of the temperature manipulating apparatus via a connecting module. The electric current then passes to the heat generating elements which may convert electrical current into physical heating. Therefore, as the electrical current passes through the heat generating elements, heat is generated which may provide heating effect to the battery of the battery warming system 100.

It may be noted that the heat generation principle used herein is different from the conventional coil heating in which heating output is achieved as a result of the resistance of the metal coils with low heating efficiency and high power loss. However, in the present subject matter, the heating effect is generated due to electric resistance of the planar structured heat generating elements, and the heating effect may be controlled by adjusting the composition and thickness of the coating layers and coating area of the heat generating elements. Electric resistance of the heat generating elements can be controlled and conductivity can be increased to generate high efficiency heating with minimal energy loss. With a reduction of the electrical resistance, the battery warming system 100 may provide fast heating and reach temperature of 200° C. while using DC electrical power source. The battery warming system 100 allows heat generation uniformly over a large surface area to maximize heating effect. In other heating techniques, due to the high electrical resistance of the heat generating elements, it may be difficult to achieve high temperatures using DC power source. The battery warming system 100 is capable of effectively maintaining the temperature of the battery to optimize the performance of the electric vehicles in cold climates.

During working of the battery working system 100, the temperature manipulating apparatus may be switched ON under a normal operation condition to maintain the air in the chamber 102 at a desired temperature. When the electric vehicle battery drops below a preset temperature and demands warming, the electric fan 103 may turn ON to blow and circulate the heated air throughout the battery warming system 100 until the desired temperature is reached.

It may be understood that when the battery warming system 100 reaches a desired preset temperature, the temperature manipulating apparatus may be switched OFF. However, when the temperature of the battery or the battery warming system 100 drops below a preset temperature and demands warming again, the temperature manipulating apparatus may be turned ON to heat up the air. Further, the electric fan 103 may be turned ON at the same time or after a defined interval to blow and circulate the heated air through the battery warming system 100 until a desired temperature is reached.

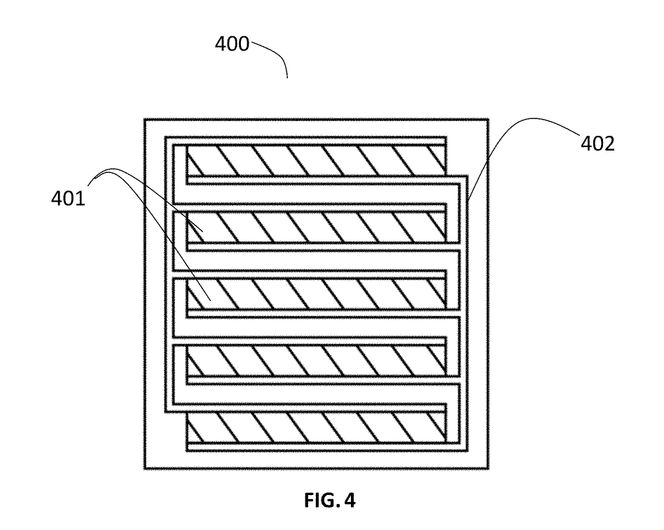

FIG. 4 shows an embodiment of a temperature manipulating apparatus 400 and an arrangement of the heat generating elements 401 and the electrodes 402 of the temperature manipulating apparatus 400. As shown in FIG. 4, the temperature manipulating apparatus may include one or more heat generating elements 401. Each heat generating element 401 may be in form of a film. The various heat generating elements 401 may be of same size or different sizes. Further, the heat generating elements 401 may possess same or different coating characteristics, such as structure, composition and thickness. Furthermore, the heat generating elements 401 may be electrically connected with one another in parallel or in series with the electrodes 402.

In all practical applications, it may be possible to configure the battery warming system 100 with a small number of heat generating elements 401 of a large heating area or a larger number of heat generating elements 401 with smaller heating area, depending upon the requirements for heating output. The heat generating elements 401 may also be placed at different positions of the battery warming system 100 in accordance with the heating requirements. Further, electrodes 402 may be provided for supply gin electric current to the heat generating elements 401.

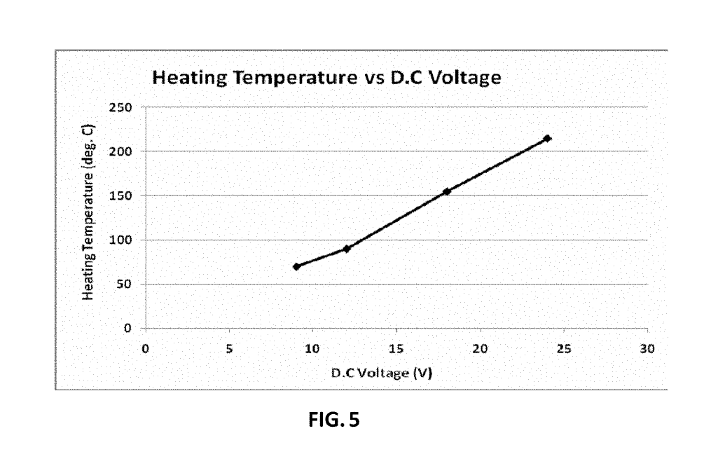

FIG. 5 shows a graphical representation of the characteristics of the temperature manipulating apparatus 400 at DC powers of 8V to 24V. It is observed that a temperature over 200° C. can be reached at 24V DC. Further, with proprietary characteristics of the heat generating elements, the temperature manipulating apparatus is capable of generating sufficient energy output at DC power to heat up the air circulating in the battery warming system 100 so as to heat and maintain the battery at an optimum temperature.

It may be noted that it may be possible to increase or decrease power output or energy consumption of the battery warming system 100 by increasing or reducing the number of temperature manipulating apparatuses 401 and by slotting in some heat generating elements 401 or taking out some heat generating elements 401 from the battery warming system 100.

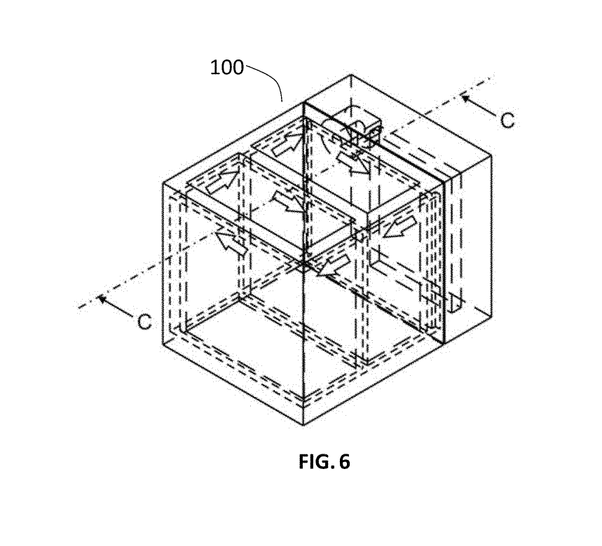

FIG. 6 shows another embodiment of the battery warming system 100 while representing a section C-C.

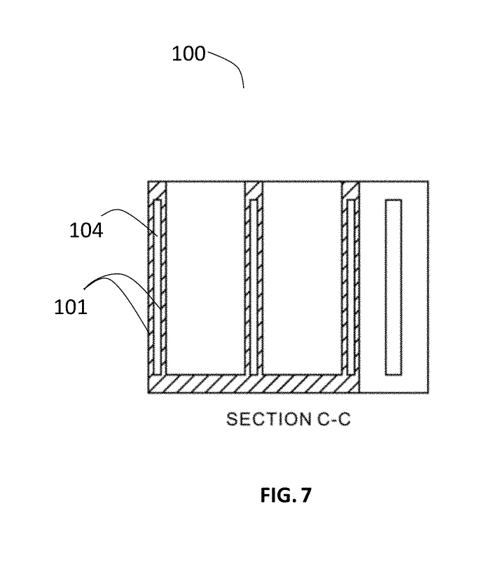

FIG. 7 shows a cross sectional view of the embodiment of the battery warming system 100, as shown in FIG. 6, along a section C-C, respectively. FIG. 7 shows another air passage channel configuration of the battery warming system 100. The air passage channels 104 may provide a larger heating area. Further, the inner walls 101 of the battery warming system 100 may be perforated to allow heated air to be better circulated within the battery warming system 100 and onto the battery. Furthermore, the air passage channels 104 may be of different forms including multiple tubing channels along each wall of the battery warming system 100.

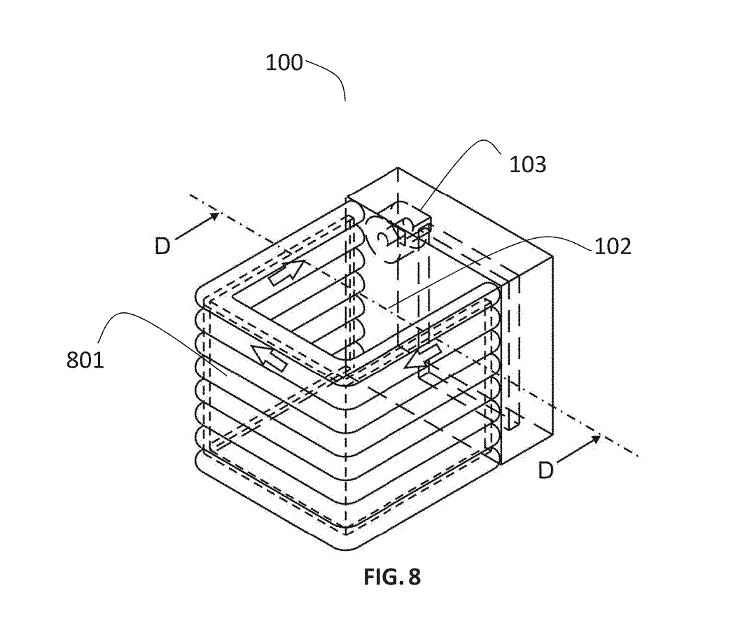

FIG. 8 shows yet another embodiment of the battery warming system 100 with an alternate configuration of air passage channels, as channels 801. The air passage channels 801, as shown in FIG. 8 may be constructed with flexible plastic channel tubing 802 surrounding the battery and connecting to the chamber 102 containing the fan 103 and the temperature manipulating apparatus. Heated air is circulated through the channels 801 to heat and maintain a desired temperature for optimum performance of the battery.

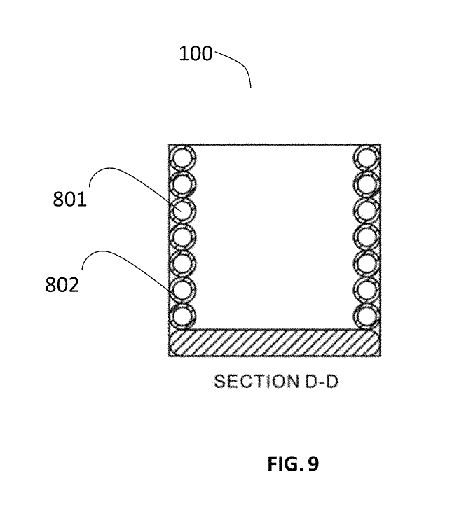

FIG. 9 shows a cross sectional view of the battery warming system 100, as shown in FIG. 8, along a section D-D. FIG. 9 shows the air passage channels 801 constructed with flexible plastic channel tubing 802. In an embodiment, as it can be seen in the FIG. 9, the air channels tubing 802 have a circular cross-section.

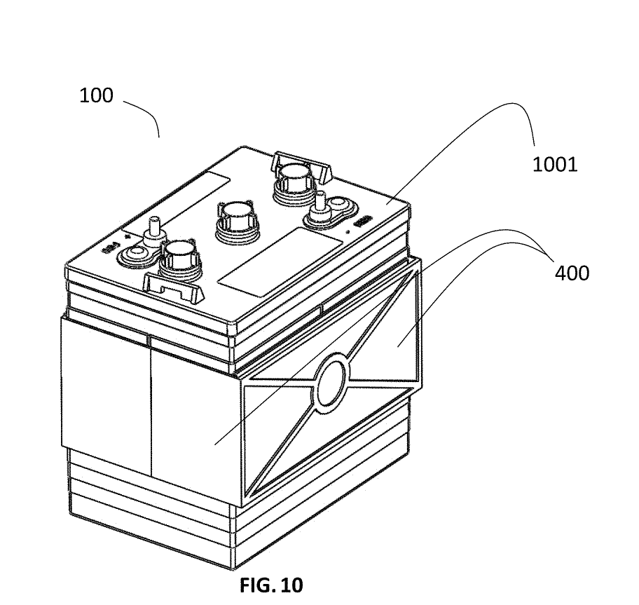

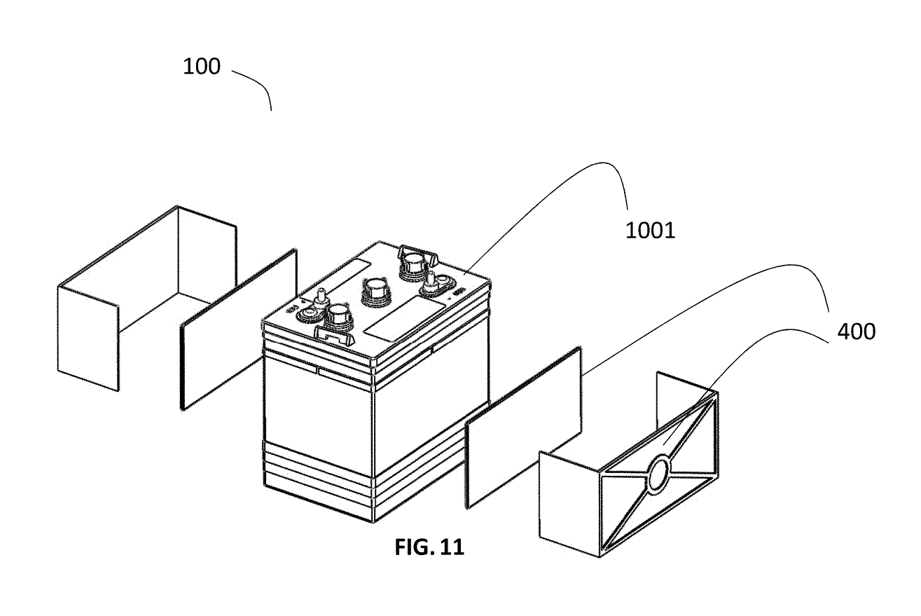

FIG. 10 and FIG. 11 show another embodiment of the battery warming system 100 with the temperature manipulating apparatuses in direct contact with the walls of the battery 1001. It can be seen in FIG. 10 that the temperature manipulating apparatuses 400 are positioned around the battery 1001 as wrapping around the battery 1001. It may be understood that in the embodiment as shown in FIG. 10, the battery warming system 100 excludes a chamber formed of plurality of walls. The heat generated by the temperature manipulating apparatuses 400 is transferred directly to the battery 1001 by way of conduction.

FIG. 11 shows a view of the configuration of the battery warming system 100, as shown in FIG. 10 showing the various components of the battery warming system 100, for providing a greater understanding of the construction of the battery warming system 100. As such, the battery warming system 100 includes a battery 1001 and temperature manipulating apparatuses 400.

In another implementation of the subject matter, the temperature manipulating apparatuses 400 are made of materials selected from plastic sheets and fabrics. The plastic sheets and fabric may be wrapped around part or whole of the battery 1001 to provide heat to the battery and maintain the temperature of the battery at an optimum temperature level. Further, the heat generating elements of the temperature manipulating apparatus 400 may be made of other electrically conductive materials, such as carbon and carbon-based materials.

### Heated Vehicle Side View Mirrors

Another application of the temperature manipulating apparatus may be in providing heated side view mirrors of the vehicle with defrosting and ice melting capacity.

It may be appreciated that in cold climatic conditions, the side view mirrors of vehicles are often covered by frost or ice, particularly in early morning or late evening. Such coating by frost and ice of the mirrors seriously affects the view of the drivers thereby compromising the safety of the riders in the vehicles. Some vehicles employ heated side view mirrors which may be heated by heating systems powered by a metal wire or a thick film heating element. However, such heating systems may manifest slow heating responses, as a result of which it may take substantially long time for the side view mirrors to de-frost or de-ice.

The present subject matter provides for a temperature manipulating apparatus implemented as a side view mirror heating system. The side view mirror heating system includes a temperature manipulating apparatus with one or more layers of conductive materials having a nano-thickness, preferably of 70 nm to 300 nm. The temperature manipulating apparatus may be deposited on the backside of the vehicle side view mirror. The temperature manipulating apparatus may be powered by the vehicle battery or a separate DC power source. In another embodiment, a separate temperature manipulating apparatus of thickness in the range of 1 mm-3 mm may be used. The temperature manipulating apparatus may be attached to the front side of the side view mirror or the back side of the side view mirror or on both sides of the side view mirror. Further, the temperature manipulating apparatuses may be held together with the side view mirrors by heat transfer gel which may be deposited between the mirror and the temperature manipulating apparatus. Furthermore, the heating member may be made of transparent ceramic glass to make the temperature manipulating apparatus transparent so that the vision from the mirror is not blocked.

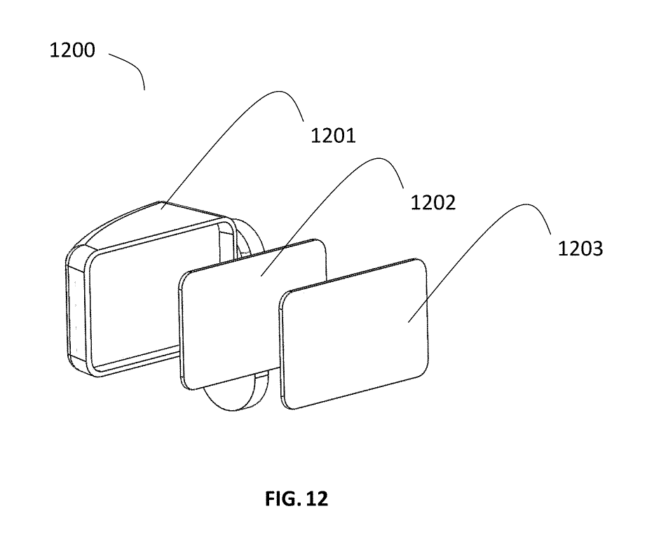

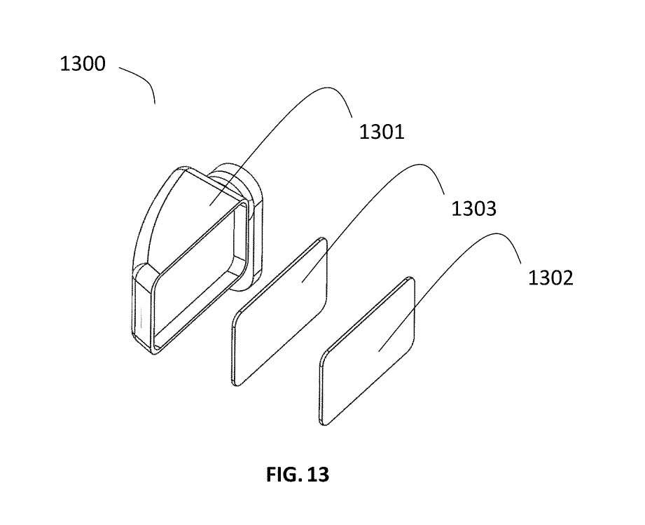

FIGS. 12 and 13 show two different embodiments of the heated vehicle side view mirrors. The embodiment of vehicle side view mirrors assembly 1200 shown in FIG. 12 includes side view mirror body 1201, a temperature manipulating apparatus 1202 and a mirror 1203. In the embodiment, the temperature manipulating apparatus 1202 is disposed behind the mirror 1203, such that the temperature manipulating apparatus 1202 is positioned between the side view mirror body 1201 and the mirror 1203.

Another embodiment of vehicle side view mirror assembly 1300 is shown in FIG. 13. The embodiment vehicle side view mirror assembly 1300 includes side view mirror body 1301, a temperature manipulating apparatus 1302 and a mirror 1303. In this embodiment, the temperature manipulating apparatus 1302 is disposed on the front side of the mirror 1303, such that the mirror 1303 is disposed between the temperature manipulating apparatus 1302 and the side view mirror body 1301.

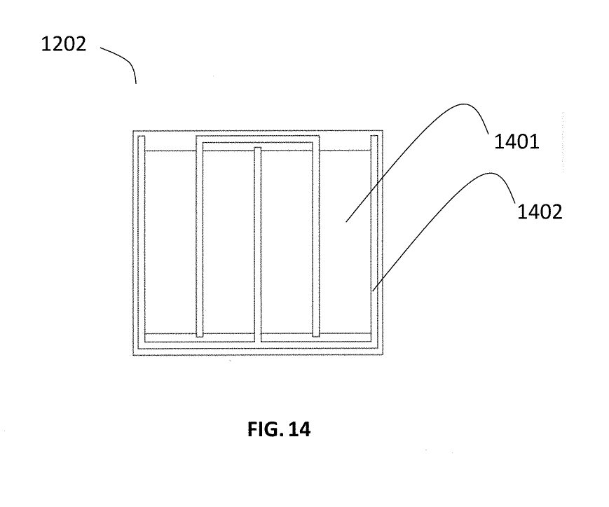

FIG. 14 shows a configuration of the temperature manipulating apparatus 1202. The temperature manipulating apparatus 1202 includes a heating film element 1401 extending across the dimensions of the temperature manipulating apparatus 1202. Further, electrodes 1402 are provided for supplying electric current to the heating film elements 1401. The temperature manipulating apparatus 1202 is adapted to operate with DC power source. It is observed that with the DC power source supplying power at electrical voltage of 13.2V and electrical current of 5 A maximum, a power output of about 66 W can be generated by the temperature manipulating apparatus 1202, and can melt ice over 80% of the area across the vehicle side view mirror in less than 4 minutes. Further, an intelligent power and temperature monitor and control system can be integrated with the temperature manipulating apparatuses 1202 in smoothing the power supply, in accordance with the temperature and heating requirement and avoid overheating of the vehicle side view mirror 1200. Further, a servo system may be provided for continuous monitoring and controlling with fast responses and in smoothing the power supply to the temperature manipulating apparatus and optimizing their heating performance and energy efficiency.

In another embodiment of the present subject matter, to enhance the heating performance, the temperature manipulating apparatus 1202, 1302 may be provided with differential energy, as a result of which temperature at the bottom regions of the of the temperature manipulating apparatus 1202, 1302, and hence the temperature at the bottom region of the vehicle side view mirror may reach up to 10° C.-30° C. higher than the top region of the mirror.

### Vehicle Heated Side Windows and Windscreens

A yet another application of the temperature manipulating apparatus, as described by the present subject matter, may be in providing heated side windows and front and rear windscreens of vehicles so as to provide defrosting and ice melting capacity.

It is observed that in cold climatic conditions, vehicle side windows and windscreens are often blocked by frost or ice, in particular in early morning or late evening, which may affect the visibility for the drivers.

The present subject matter provides for a temperature manipulating apparatus implemented as vehicle heated side windows and windscreens heating system. The heating system may employ a temperature manipulating apparatus providing heating effect by using electricity.

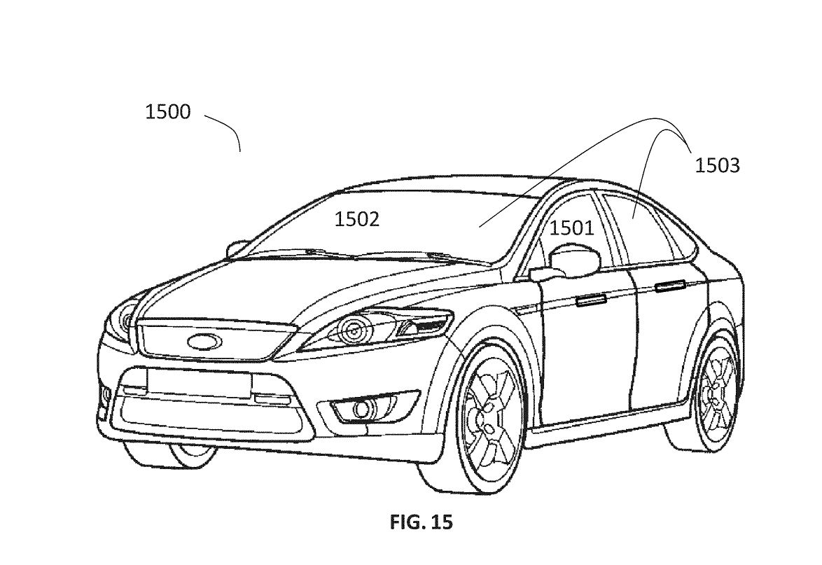

FIG. 15 shows a vehicle 1500 with heated side windows and windscreens. The side windows 1501 and the windscreens 1502 of the vehicle 1500 are provided with temperature manipulating apparatus 1503. The temperature manipulating apparatus 1503 may be attached over the surface of the side windows 1501 and windscreens 1502 of the vehicle 1500. Further, the temperature manipulating apparatus may be transparent in nature to allow viewing through the temperature manipulating apparatus 1503 applied on side windows 1501 and the windscreens 1502 of the vehicle 1500.

In an embodiment, the temperature manipulating apparatus 1503 may have thickness in the range of 1 mm-3 mm. The temperature manipulating apparatus 1503 may be powered by the vehicle battery or a separate DC power source. Furthermore, the construction of the temperature manipulating apparatus 1503 may include transparent ceramic glass substrate as the base medium with the heating film elements deposited over the base medium. The temperature manipulating apparatus may further be of different sizes to cover some parts or the whole of the side windows and windscreens.

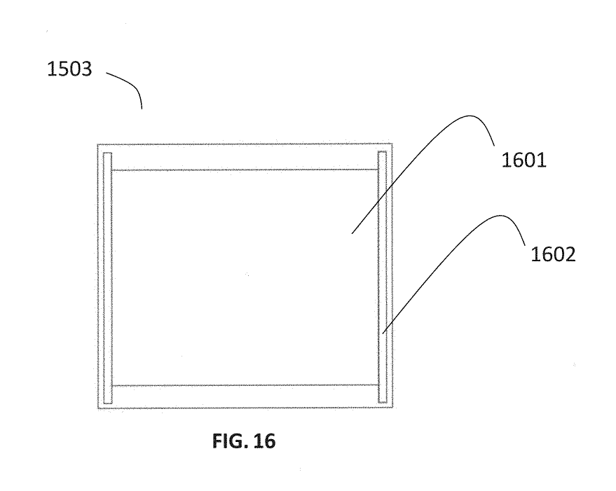

FIG. 16 shows an embodiment of the temperature manipulating apparatus 1503 with a heating film element 1601 covering almost the whole area of the temperature manipulating apparatus 1503. The temperature manipulating apparatus 1503 includes electrodes 1602 for supplying electric current to the heating film element 1601.

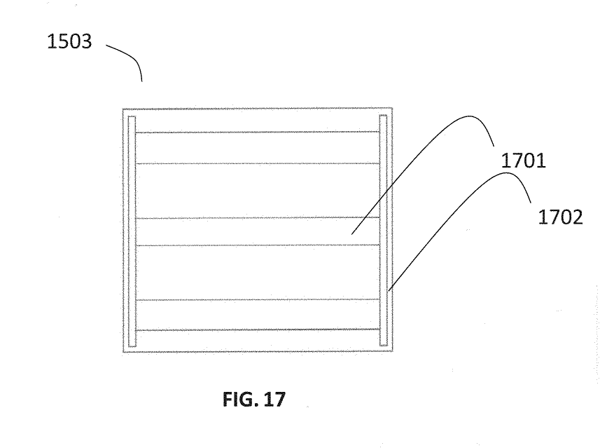

FIG. 17 shows another embodiment of the temperature manipulating apparatus 1503 with a plurality heating film elements formed as heating film strips 1701 and separated by non-heating-film interspaces. The heating film strips 1701 are connected with electricity conducting electrodes 1702 along the edges.

As mentioned earlier, the heated vehicle side windows and windscreens system may be an adaptation of the temperature manipulating apparatus described before. Accordingly, the temperature manipulating apparatus 1503 of the heated vehicle side windows and windscreens system may be made of ceramic glass or other suitable materials as base medium, and the heat generating film elements made of one or more layers of nano-thickness of conductive coatings, preferably of 70 nm to 300 nm. The temperature manipulating apparatus 1503 may be powered by the vehicle battery or a separate DC power source. The temperature manipulating apparatus 1503 may be of thickness in the range of 1 mm-3 mm. Further, the temperature manipulating apparatuses may be held together with the surface of the windows and windscreen by heat transfer gel. The temperature manipulating apparatuses 1503 may be made of transparent ceramic glass to impart characteristics of transparency.

### Vehicle Heated Door Handles and Door Trims

Another application of the temperature manipulating apparatus may be in providing heated door handles and door rims of vehicles.

In cold climates, vehicle doors and door handles may become frozen by snow and ice, which may make the door handle difficult to be touched and hence the door difficult to be opened. To counter the problem, a vehicle heated door handles and door rims system is described. The vehicle heated door handles and door rims system may include a temperature manipulating apparatus, a power source and a connecting module connecting the power source with the temperature manipulating apparatus. The temperature manipulating apparatus may include heating film elements made of one or more layers of conductive materials. The temperature manipulating apparatus may be disposed on some parts or the whole of the door handle or door rim of the vehicle 1800. The temperature manipulating apparatus may further be powered by the vehicle battery or a separate DC power source. Over the temperature manipulating apparatus, an electrical insulation material layer may be deposited to cover the conductive heating film element.

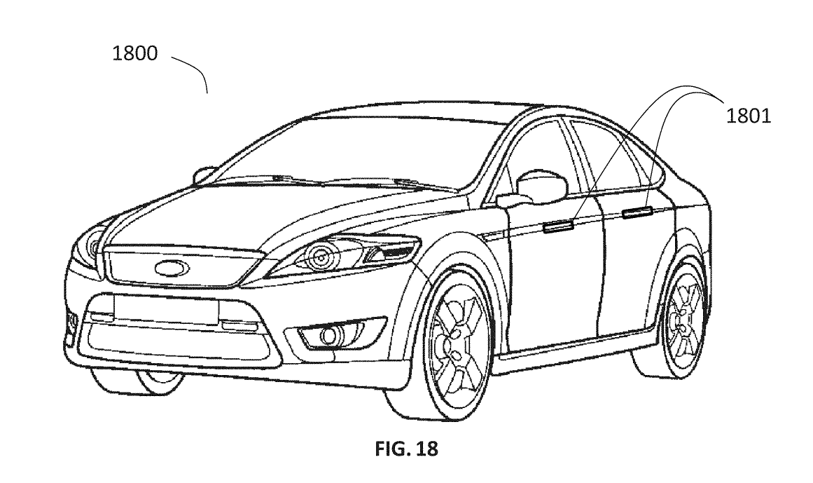

FIG. 18 shows a vehicle 1800 employing the vehicle heated door handles 1801. As shown in FIG. 18, the vehicle may employ a temperature manipulating apparatus (not shown in FIG. 18) applied over the door handles 1801 of the vehicle 1800. The temperature manipulating apparatus may be attached over the surface of the door handles 1801. Further, the temperature manipulating apparatus may be transparent in nature so as to maintain the vehicle visual aesthetics. In an embodiment, the temperature manipulating apparatus may have thickness in the range of 1 mm-3 mm, and may be powered by the vehicle battery or a separate DC power source.

### Vehicle Heated Steering Wheels, Armrest, Seats and Door Trim

Another application of the temperature manipulating apparatus may be in providing heated steering wheels, armrest, seats and door trim in vehicles. As mentioned earlier, temperature manipulating apparatus may be provided over the various components parts of a vehicle to be heated.

The temperature manipulating apparatus may have the same constructional features as discussed in the above implementations.

The temperature manipulating apparatus may be of different sizes to cover some parts or the whole of the vehicle steering wheel, armrest, seats and door trim. The temperature manipulating apparatus may include a heat generating film deposited over a base medium. The heating film may be deposited by way of a various process, such as spraying process, printing process, roll-to-roll process, and vacuum deposition process. The heating film may be of different sizes and patterns, as per the power output requirement.

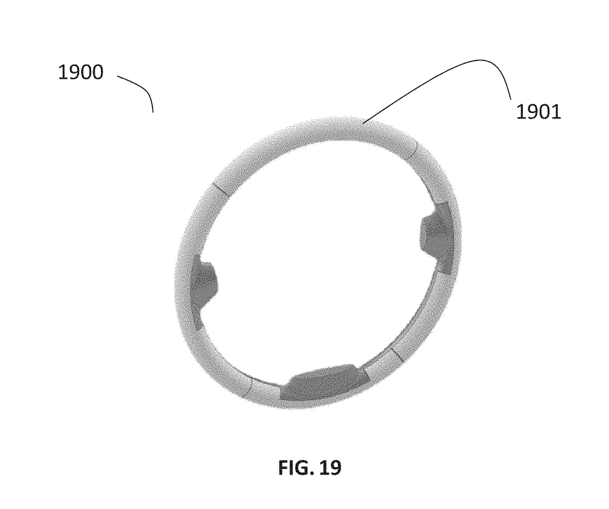

FIG. 19 shows an embodiment of a heated steering wheel 1900 for use in a vehicle. A temperature manipulating apparatus 1901 may be made of a flexible base medium applied by way of wrapping around the surface of the steering wheel 1900. Further, the temperature manipulating apparatus 1901 may be transparent so as not to distort the visual aesthetics. In an embodiment, the temperature manipulating apparatus 1901 may have thickness in the range of 1 mm-3 mm, and may be powered by the vehicle battery or a separate DC power source.

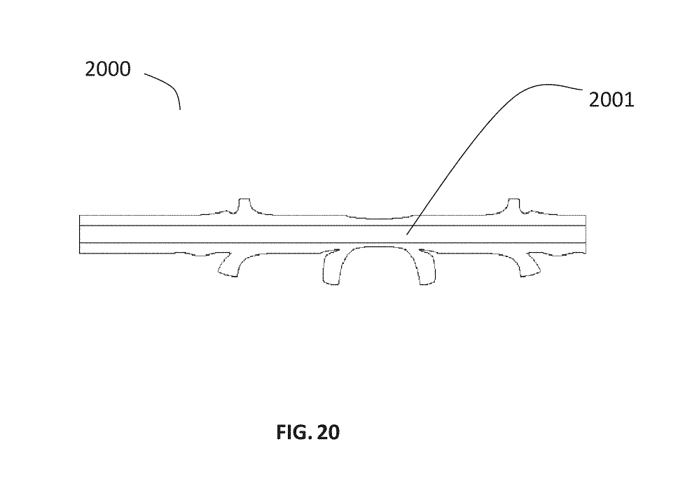

FIG. 20 shows a general embodiment of a temperature manipulating apparatus wrap 2000. The temperature manipulating apparatus wrap 2000 includes a temperature manipulating apparatus 2001. The temperature manipulating apparatus wrap 2000 may be employed for providing heating to the various components of the vehicle discussed above by wrapping around the components.

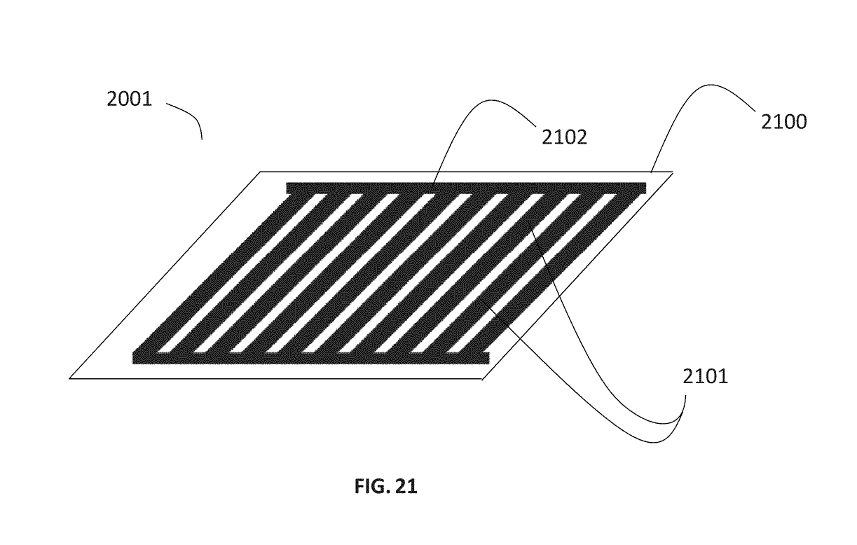

FIG. 21 shows an embodiment of the temperature manipulating apparatus 2001, as shown in FIG. 20, for use in the various vehicle components. The temperature manipulating apparatus 2001 includes a base medium 2100. In an embodiment, the base medium 2100 may be in form of a transparent film. In other implementations, the temperature manipulating apparatus 2001 may also be a leather sheet, a fabric sheet, a one-sided glue tape or a plastic sheet. Further, it can be seen in the current embodiment, the temperature manipulating apparatus 2001 includes a plurality of heat generating film strips 2101. In case of a transparent film, the plurality of film strips 2101 may be formed by screen printing process. Further, the temperature manipulating apparatus 2001 includes electrodes 2102 that are provided for supplying the electric current to the film strips 2101. The electrodes 2102 may be made up of general electricity conducting material. In an embodiment, the heating film strips 2101 are separated by non-heating-film interspaces. The heating film strips 2101 may be connected with electricity conducting electrodes 2102. The heating film strips 2101 may be adapted to conduct heat when electricity passes through them. In an embodiment, two electrically conductive electrodes 2102 are arranged parallel to each other. In an embodiment, the electrically conductive electrodes 2102 are placed on the edges of the base medium 2100. The heating film strips 2101 are arranged between the two electrodes 2102 with the heating film strips 2101 being electrically connected in parallel. To achieve uniform heating across the temperature manipulating apparatus 2001 and hence across the surface of the steering wheel 1900 and other components like vehicle seat, the film strips 2101 of the temperature manipulating apparatus 2001 may be inclined at an angle, preferably at an angle of 45°.

It may be noted that the heating film strips 2101 may be arranged with respect to the electrodes 2102 at an angle ranging from 0° to 90°. In an embodiment of the temperature manipulating apparatus 2001, as shown in FIG. 21, heating film strips 2101 are arranged at angle of 45° to the electrodes 2102. The arrangement allows to form different shapes of the temperature manipulating apparatus 2001 to suit different shapes of various components requiring heating.

Further, heating film strips 2101 may be arranged such that there are interspaces created and maintained between adjacent heating film strips 2101. The provision interspaces may allow for efficient heating by the temperature manipulating apparatus 2001 under limited power supply from the D.C. power source in a vehicle. Further, the widths of the film strips 2101 and the non-heating-film interspaces may be maintained in specific ratios as per the requirement. It may be understood that a higher ratio implies a greater density of the heating film strips 2101 as compared to the interspaces in the temperature manipulating apparatus 2001, which thereby implies greater heating effect achieved by the temperature manipulating apparatus 2001. On the other hand, a lower ratio may imply a lower density of the heating film strips 2101 in the temperature manipulating apparatus 2001, which thereby may result in a lower heating effect. As such, the ratio of the width of the heating film strips 2101 and the non-heating-film interspaces may range from 1:1 to 3:1 or at any other suitable ratios.

Further, to achieve sufficient heat energy to heat up the vehicle steering wheel 1900 and other vehicle components, the power density of the temperature manipulating apparatus 2001 is designed to generate a power density of 1.0-2.0 mW/mm² with the vehicle battery at 13.2V. With this power density, the temperature manipulating apparatus 2001 may reach a temperature rise of 40-50° C. within a minute and provide fast warm up of the vehicle components. In other embodiments, the temperature may be maintained at a particular temperature that causes no discomfort to the user. In an embodiment, the user may also be able to control the temperature as per his own comfort.

By way of an example, the temperature manipulating apparatus 2001 may include the one-sided glue tape as the base medium 2100. The one-sided glue tape may be in a transparent form. In this embodiment, the whole structure that includes the electrodes 2102 and the heating film strips 2101 may be formed on the side without glue. This makes, sticking of the temperature manipulating apparatus 2001, easy to any surface. Hence, the temperature manipulating apparatus 2001 may be easily applied to any surface for which temperature manipulation is required. The heating film strips 2101 may also be sprayed, printed or vacuum deposited on other flexible base medium such as leather, fabric or plastic.

By way of another example, the base medium 2100 of the temperature manipulating apparatus may be a fabric sheet, as also described earlier. The fabric sheet may be placed over the steering wheel of the vehicle and may be sewn. Since the fabric sheet needs to be sewn hence, it is taken care to place the electrodes at appropriate distance from edges of the fabric sheet.

By way of another example, the base medium 2100 of the temperature manipulating apparatus may be a leather sheet, as also described earlier. The leather sheet may be placed over the steering wheel of the vehicle and may be sewn. In other implementations, the leather sheet may be placed on the steering wheel using other fastening means like buttons, zippers, etc.

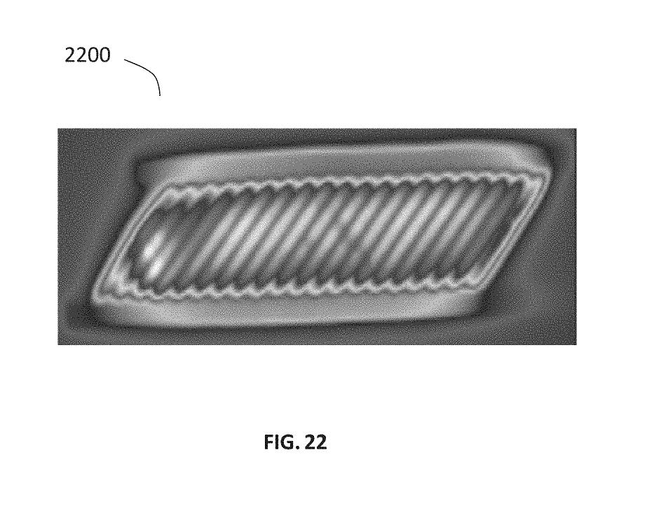

FIG. 22 shows a thermal image 2200 of temperature distribution on the temperature manipulating apparatus 2001. It can be observed from the thermal image 2200 that the temperature at the central regions of the temperature manipulating apparatus 2001 may be higher as compared to the peripheral regions of the temperature manipulating apparatus 2001. Further, the temperature patterns reflect the configuration of the heating film elements 2101.

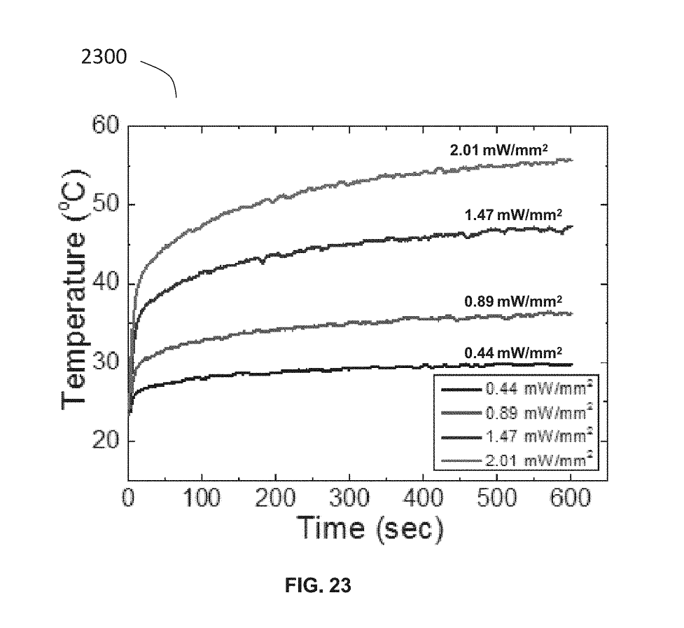

FIG. 23 shows a graphical representation 2300 of the heating performance of the temperature manipulating apparatus 2001, at different power densities. A trend of rise in temperature (in ° C.) of the temperature manipulating apparatus or the heated component with time (in seconds) at different power densities can be studied. For example, the temperature of the temperature manipulating apparatus or the heated component may reach up to 55° C. in 500 seconds when the power input is 2.01 mW/mm².

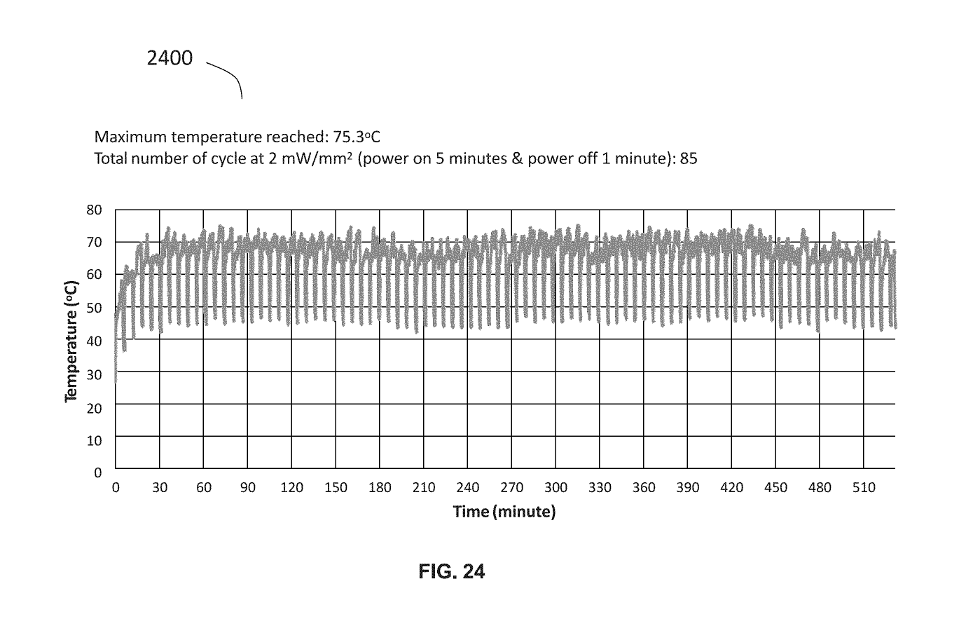

FIG. 24 shows another graphical representation 2400 of the cyclic test results of the temperature manipulating apparatus 2001 with power ON for 5 minutes and power off for 1 minute in each cycle. At a power density of 2 mW/mm², the temperature manipulating apparatus 2001 reaches over 75° C. and the temperature and heating performance are repeatable in the cyclic tests. Further, an intelligent power and temperature monitor and control system can be integrated with the temperature manipulating apparatus 2001 for smoothening the power supply to the temperature manipulating apparatus 2001 in accordance with the temperature and heating requirement and avoid overheating of the vehicle components like the steering wheel, door handles, windows, windscreens and battery.

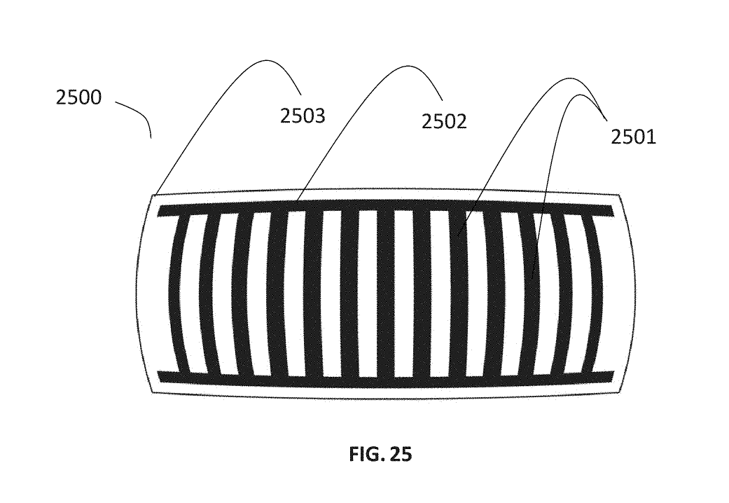

FIG. 25 shows another embodiment of the temperature manipulating apparatus 2500. The temperature manipulating apparatus 2500 includes a base medium 2503. In an embodiment, the base medium may be in form of a transparent film. In other implementations, the temperature manipulating apparatus 2503 may also be a leather sheet, a fabric sheet, a one-sided glue tape or a plastic sheet. Further, the temperature manipulating apparatus 2500 includes a plurality of heating film strips 2501 of various curvature and thickness, and electrodes 2502 connecting the heating film strips 2501 in parallel. In case of a transparent film, the plurality of film strips 2501 may be formed by screen printing process. The electrodes 2501 may be made up of general electricity conducting material.

It may be understood that the curvature of the heating film strips 2501 may be provided for better fitting around the shape of the vehicle components like the steering wheel. To maximize the heating area of the temperature manipulating apparatus 2500, some of the heating strips 2501 are made of propriety structure of curvature to fit the barrel-shaped geometry of the temperature manipulating apparatus 2500. In an embodiment, the electrically conductive electrodes 2502 are placed on the edges of the base medium 2503.

In an embodiment of the temperature manipulating apparatus 2500, as shown in FIG. 25, the heating film strips 2501 in the central region of the temperature manipulating apparatus 2500 are of a straight configuration with the curvature of the strips gradually increasing towards the outer region of the temperature manipulating apparatus 2500. In this embodiment, the heating film strips 2501 at the center of the temperature manipulating apparatus 2500 have a curvature of infinite radius. This implies, that these heating film strip 2501 at the center are essentially straight in shape with little to zero extent of curvature. However, the extent of curvature of the heating film strips 2501 gradually increases along the length of the temperature manipulating apparatus 2500 from the center to the outer regions. As a result, the radius of curvature of the heating film strips 2501 will gradually decrease from the central region towards the outer regions of the temperature manipulating apparatus 2500.

Further, in an embodiment of the temperature manipulating apparatus 2500, the ratio of the change of the radius of curvature of the adjoining heating film strips 2501 may be defined within a range of 20%-99.9% with the ratio of change of the radius of curvature gradually decreased from 99.9% at the central region of the temperature manipulating apparatus 2500 to 20% at the outer region of the temperature manipulating apparatus 2500.

In addition, for creating equal or similar amount of heat energy output, and hence achieving same or close heating temperature between the straight and curved heating film strips 2501, the width of each heating film strip 2501 may decrease from the central region towards the outer region. In an embodiment of the heating 2500, the ratio of width decreases between the adjoining heating film strips 2501 is defined within 0%-20%, with the ratio of width decrease between the two adjoining heating film strips 2501 gradually increases from 0% at the central region to 20% at the outer region of the temperature manipulating apparatus 2500.

In an embodiment of the temperature manipulating apparatus 2500, the temperature manipulating apparatus 2500 is of a barrel-shaped geometry. It may be further understood that such a barrel shaped geometry of the temperature manipulating apparatus 2500 may allow for the temperature manipulating apparatus to suitably fit into the round shaped components of vehicles, such as the steering wheel and the door handles.

Further, to achieve sufficient heat energy to heat up the steering wheel, seats, armrests and other vehicle components, the power density of the temperature manipulating apparatus 2500 is designed to generate a power density of 1.0-2.0 mW/mm² with the vehicle battery at 13.2V. With this power density, the temperature manipulating apparatus 2500 may reach a temperature rise of 40-50° C. within a minute and provide fast warm up of the vehicle components. In other embodiments, the temperature may be maintained at a particular temperature that causes no discomfort to the user. In an embodiment, the user may also be able to control the temperature as per his own comfort.

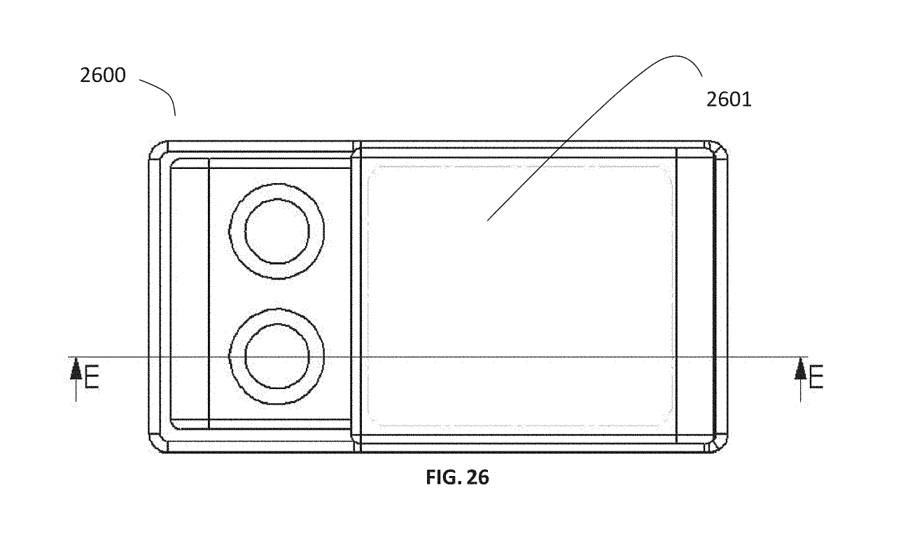

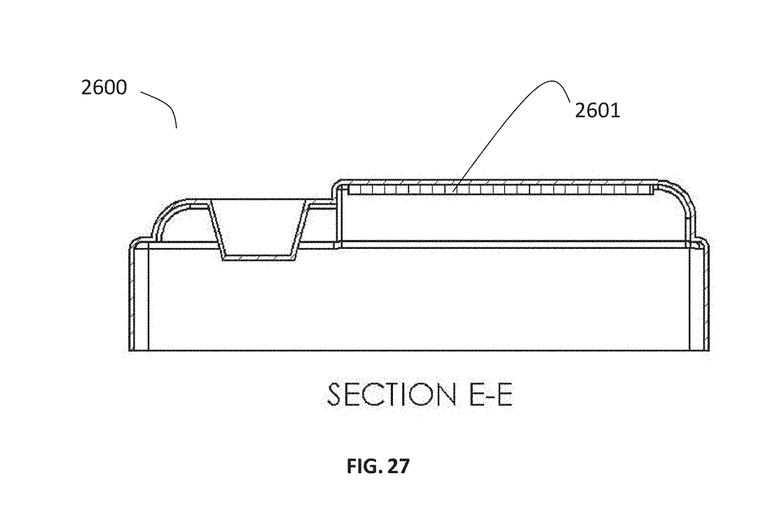

FIGS. 26 and 27 show different views of an embodiment of a heated armrest 2600 of a vehicle.

FIG. 26 shows a heated armrest 2600. The armrest 2600 may be provided a temperature manipulating apparatus 2601 wrapped around the surface of the armrest 2600. Further, the temperature manipulating apparatus 2601 may be transparent to preserve the visual aesthetics. In an embodiment, the temperature manipulating apparatus 2601 may have thickness in the range of 1 mm-3 mm, and may be powered by the vehicle battery or a separate DC power source.

FIG. 27 shows a cross-sectional view of the heated armrest 2600 along a section E-E. In the given embodiment, it may be seen that a temperature manipulating apparatus 2601 is attached underneath the armrest 2600.

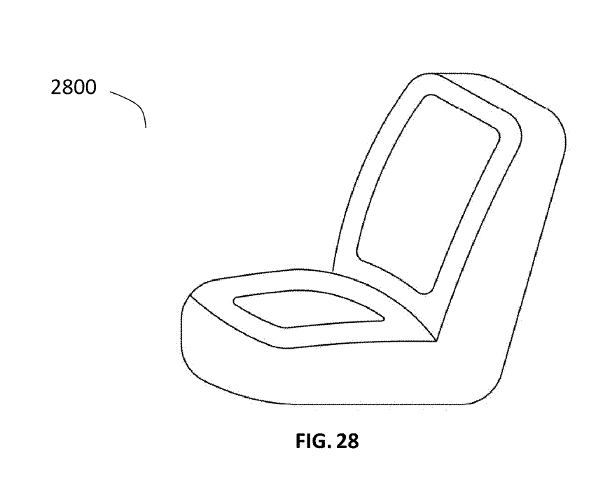

FIG. 28 shows an embodiment of a heated seat 2800 in a vehicle. The heated seat 2800 includes a temperature manipulating apparatus (not shown) provided for generating a heating effect. In an embodiment of the heated seat 2800, the temperature manipulating apparatus is provided underneath the seat cover.

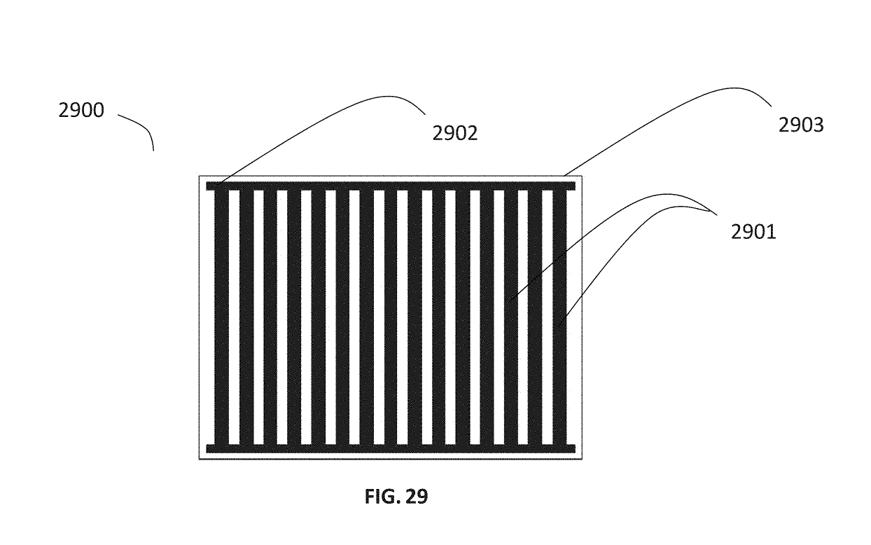

FIG. 29 shows an embodiment of the temperature manipulating apparatus 2900 to be utilized for providing heating to the heated armrest 2600 and the heated seat 2800 of the vehicles. The temperature manipulating apparatus 2900 includes a base medium 2903. In an embodiment, the base medium 2903 may be in form of a fabric sheet, or a leather sheet. In other implementations, the temperature manipulating apparatus 2900 may also be a one-sided glue tape or a plastic sheet. Further, it can be seen in the FIG. 29, that the temperature manipulating apparatus 2900 includes a plurality of electrodes 2902 and a plurality of heating film strips 2901. The electrodes 2902 may carry and supply electric current to the heating film strips 2901, and the heating film strips 2901 may convert the electric energy supplied by the electrodes 2902 into heating effect.

In the embodiment of the temperature manipulating apparatus 2900, as shown in FIG. 29, has a regular configuration with a plurality of heating film elements 2901 arranged parallel to each other. The heating film elements 2901 may be of equal width and length across the temperature manipulating apparatus 2900. Further, electrical electrodes 2902 are provided for supplying electricity to the heating film elements 2901. The electrodes 2902 may be made up of general electricity conducting material. As shown in FIG. 29, the electrical electrodes 2902 are arranged parallel to each other, such that the plurality of the heating film strips 2901 are arranged between the electrical electrodes 2902. It may be understood that the width of the heating film strips 2901 may be varied as per the heating requirements. Further, interspaces may be provided between the heating film strips 2901 to vary the intensity of the heating effect produced by the temperature manipulating apparatus 2900. The widths of the film strips 2901 and the interspaces may be maintained in specific ratios as per the requirement. It may be understood that a higher ratio implies a greater density of the heating film strips 2901 as compared to the interspaces in the temperature manipulating apparatus 2900, which thereby implies greater heating effect achieved by the temperature manipulating apparatus 2900. On the other hand, a lower ratio may imply a lower density of the heating film strips 2901 in the temperature manipulating apparatus 2900, which thereby may result in a lower heating effect. As such, the ratio of the width of the heating film strips 2901 and the non-heating film interspaces may range from 1:1 to 3:1 or at any other suitable ratios.

Further, to achieve sufficient heat energy to heat up the seats, armrests and other vehicle components, the power density of the temperature manipulating apparatus 2900 is designed to generate a power density of 1.0-2.0 mW/mm² with the vehicle battery at 13.2V. With this power density, the temperature manipulating apparatus 2900 may reach a temperature rise of 40-50° C. within a minute and provide fast warm up of the vehicle components. In other embodiments, the temperature may be maintained at a particular temperature that causes no discomfort to the user. In an embodiment, the user may also be able to control the temperature as per his own comfort.

By way of an example, the temperature manipulating apparatus 2900 may include the one-sided glue tape as the base medium 2903. The one-sided glue tape may be in a transparent form. In this embodiment, whole structure that includes the electrodes 2902 and the heating film strips 2900 may be formed on the side without glue. This makes, sticking of the temperature manipulating apparatus 2900, easy to any surface. Hence, the temperature manipulating apparatus 2900 may be easily applied to any surface for which temperature manipulation is required. The one-sided glue can be placed and stuck to inner side of the armrest 2600.

By way of another example, the base medium 2903 of the temperature manipulating apparatus 2900 may be a fabric sheet, as also described earlier. The fabric sheet may be placed over the car seat 2800 of the vehicle and may be sewn or placed over the seat 2800. Since the fabric sheet needs to be sewn hence, it is taken care to place the electrodes 2902 at appropriate distance from edges of the fabric sheet.

By way of another example, the base medium 2903 of the temperature manipulating apparatus 2900 may be a leather sheet, as also described earlier. The leather sheet may be placed over the seat 2800 of the vehicle and may be sewn. Since the leather sheet needs to be sewn hence, it is taken care to place the electrodes 2902 at appropriate distance from edges of the fabric sheet. In other implementations, the leather sheet may be placed on the seat using other fastening means like buttons, zippers, etc.

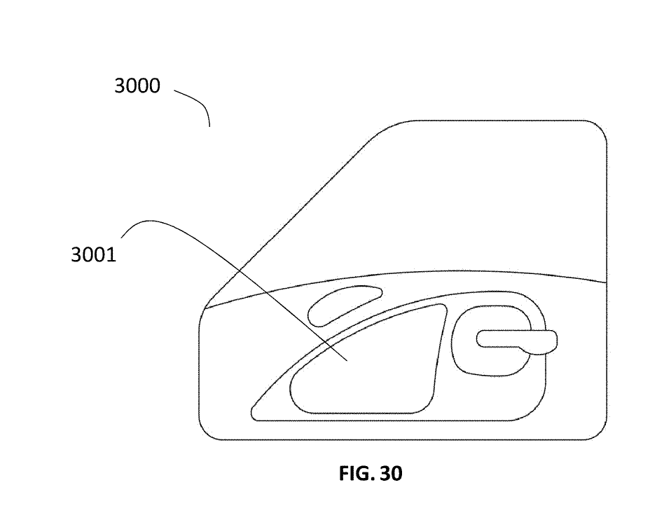

FIG. 30 shows an embodiment of a heated door trim 3000 in a vehicle. It can be seen that the heated area 3001 of the door trim 3000 is of triangle shaped geometry. A temperature manipulating apparatus is therefore applied on the heated area 3001. It may be understood that the temperature manipulating apparatus may include heating film elements made of layers of conductive material. The heating film elements may utilize electrical current generate heating effect to heat the area 3001 of the door trim 3000 of the vehicle.

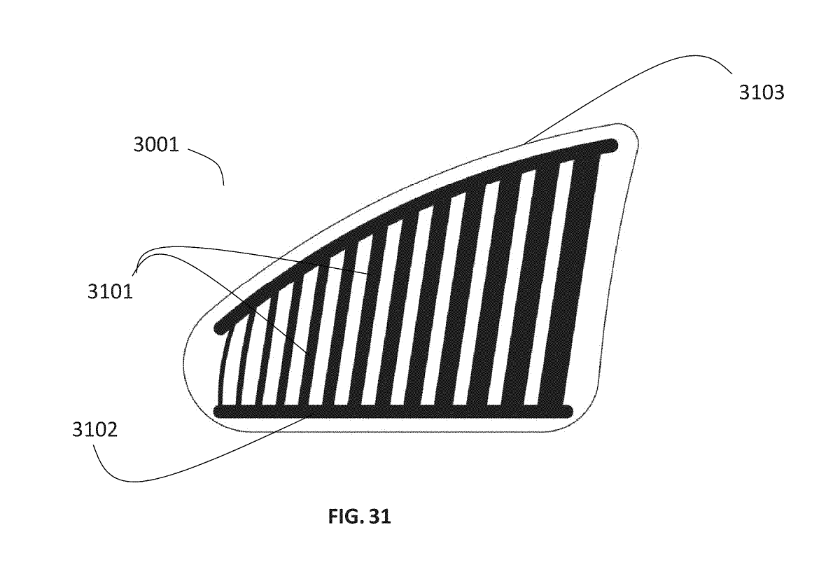

FIG. 31 shows yet another embodiment of the temperature manipulating apparatus 3001 adapted for being applied on door trim 3000 of the vehicle for the purpose of heating the door trim 3000. The temperature manipulating apparatus 3001 includes a base medium 3103. In an embodiment, the base medium may be in form of a transparent film. In other implementations, the temperature manipulating apparatus 3103 may also be a leather sheet, a fabric sheet, a one-sided glue tape or a plastic sheet. Further, the temperature manipulating apparatus 3001 include heating film strips 3101 and electrodes 3102. The heating film strips 3101 may be of various curvature, length and thickness. In case of a transparent film, the plurality of film strips 3101 may be formed by screen printing process. The electrodes 3102 may be made up of general electricity conducting material.

In the embodiment of the temperature manipulating apparatus 3001, as shown in FIG. 31, the electrodes 3102 are arranged transverse to each other. In other words, the electrodes 3102 are arranged at angle to each other, such that along the length of the temperature manipulating apparatus 3001, distance between the two electrodes 3102 varies. Consequentially, the size of the heating elements 3101 arranged between the two electrodes may also vary. The arrangement of the temperature manipulating apparatus 3001 allows for suiting to the shape and maximizing the heating area of the components like the door trim. However, it can be seen that the configuration creates unequal separation between the two electrodes 3102 across each heating film strip 3101. Therefore, to enable equal or similar amount of heat energy be generated from each heating film strip 3101, and achieve similar temperature across each heating strip area, a proprietary structural configuration of the heating film strips 3101 is defined and applied. In an embodiment, the electrically conductive electrodes 3102 are placed on the edges of the base medium 3103.

Accordingly, length of the heating film strips 3101 gradually decreases along the length of the heated area. The change in the lengths between two adjoining heating film strips 3101 may be in a ratio in the range of 5%-30%, preferably 5% at the long side of the heated area towards 30% at the short side of the heated area. To maintain the same or similar amount of heat energy output and hence maintain a consistent temperature between each heating film strip 3101, the width of the heating film strips 3101 may gradually decrease from the long side towards the short side of the heating film strips 3101. The decrease of the widths along two adjoining heating film strips may be of a ratio in the range of 10%-30%, preferably 10% at the long side of the heated area towards 30% at the short side of the heated area. The heating film strips 3101 at the end of the short side of the heating area may be of a straight geometry or of a curved geometry, as required.

Further, to achieve sufficient heat energy to heat up the door trims and other vehicle components, the power density of the temperature manipulating apparatus 3001 is designed to generate a power density of 1.0-2.0 mW/mm² with the vehicle battery at 13.2V. With this power density, the temperature manipulating apparatus 3001 may reach a temperature rise of 40-50° C. within a minute and provide fast warm up of the vehicle components. In other embodiments, the temperature may be maintained at a particular temperature that causes no discomfort to the user. In an embodiment, the user may also be able to control the temperature as per his own comfort.

By way of an example, the temperature manipulating apparatus 3001 may include the one-sided glue tape as the base medium 3103. The one-sided glue tape may be in a transparent form. In this embodiment, whole structure that includes the electrodes 3102 and the heating film strips 3101 may be formed on the side without glue. This makes, sticking of the temperature manipulating apparatus 3001, easy to any surface. Hence, the temperature manipulating apparatus 3001 may be easily applied to any surface for which temperature manipulation is required.

By way of another example, the base medium 3103 of the temperature manipulating apparatus may be a fabric sheet, as also described earlier. The fabric sheet may be placed over the door trim 3000 of the vehicle and may be sewn. Since the fabric sheet needs to be sewn hence, it is taken care to place the electrodes at appropriate distance from edges of the fabric sheet.

By way of another example, the base medium 3103 of the temperature manipulating apparatus may be a leather sheet, as also described earlier. The leather sheet may be placed over the door trim 3000 of the vehicle and may be sewn. Since the leather sheet needs to be sewn hence, it is taken care to place the electrodes 3102 at appropriate distance from edges of the fabric sheet. In other implementations, the leather sheet may be placed on the door trim 3000 using other fastening means like buttons, zippers, etc.

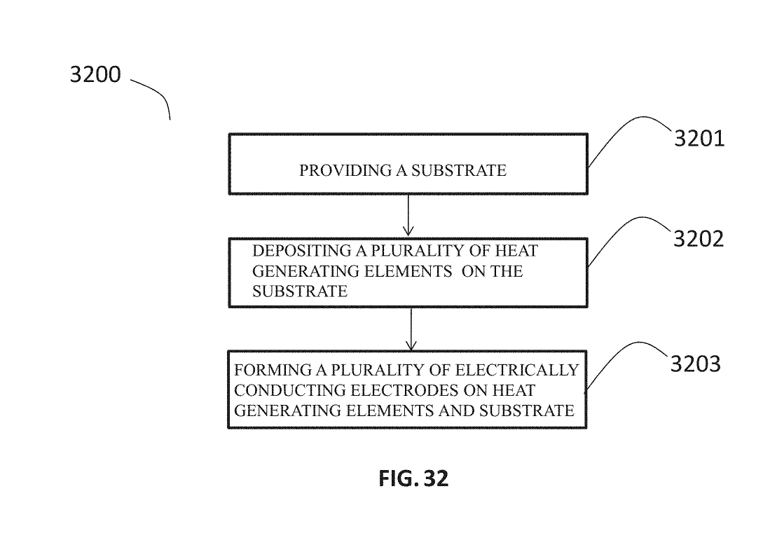

The present subject matter further describes a method 3200, illustrated by FIG. 32, of making a temperature manipulating element, or a heat generating element. The method includes, firstly, providing 3201 a substrate. The substrate, as mentioned earlier, may be a rigid material selected from glass, ceramic and any other suitable materials. Further, the base medium may be a flexible material selected from fabric, leather, plastic, one sided glue tape, transparent film and any other suitable flexible material.

Thereafter, the method includes depositing a plurality of heat generating elements 3202 on the base medium. The heat generating elements may be deposited in form of one or more layers deposited, printed or laminated upon the base medium. Each of the one or more layers may have thickness in the range of a 70 nanometers (nm) to 500 nanometers (nm). Preferably, the thickness of each of the layers may be kept in the range of 100 nm to 300 nm when deposited on a base medium of ceramic glass or a flexible base medium made of plastic or fabrics or leather. The heat generating elements may be disposed in layers of a planar structure, such that the heat generating elements are spread all over the layers and are evenly spaced to ensure optimum matching between the electrodes and the layers and the substrate. The disposition of the heat generating elements with respect to the layer results in minimal electrical resistance and improved electrical and heat conductivity across the layers.

Once the substrate and the heat generating elements are provided, the method further includes forming a plurality of electrically conducting electrodes 3203 on the heat generating elements and the substrate by way of depositing the electrodes on the heat generating elements and the substrate. The electrodes may be made of electrically conductive materials and adapted to carry the electric current supplied by the electrical power source.

The applications described above are some examples showing a wide range of applications applicable by the heat generation system of the present patent in vehicles and automotive industry, and relate to a new temperature manipulating made of glass or other suitable materials with capability of providing high performance and energy efficient multiple heating while being powered by DC power sources. The described temperature manipulating can be designed and built in other forms and be utilized, including but not limiting in other automotive applications and/or applications in other industrial and commercial areas.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A temperature manipulating apparatus comprising;
a base medium;
a plurality of heat generating elements, wherein the plurality of heat generating elements are disposed on the base medium, wherein further the heat generating elements comprises embedded metallic or carbon-based nano-particles, nano-tubes or nano-wires having diameter of less than 100 nm;
a plurality of electricity conducting electrodes, wherein the plurality of electricity conducting electrodes are disposed on the heat generating elements and the base medium, wherein the plurality of electricity conducting electrodes are configured to receive electricity from an electrical power source;
wherein further, the plurality of heat generating elements are connected to the plurality of electricity conducting electrodes to receive electricity, wherein upon receiving electricity, the plurality of heat generating elements generate heat.

2. The temperature manipulating apparatus of claim 1, wherein the base medium is rigid, or flexible.

3. The temperature manipulating apparatus of claim 2, wherein the flexible base made from materials selected from a plastic, a fabric, a leather sheet, a transparent film and a single sided glue tape.

4. The temperature manipulating apparatus of claim 1, wherein the heat generating elements are made from source materials selected from a group comprising a tin, indium, cadmium, vanadium, silver and carbon.

5. The temperature manipulating apparatus of claim 4, wherein the heat generating elements comprise of precursors selected from a group comprising a Monobutyl Tin Tri-chloride, N-Methyl-2-pyrrolidone, Dimethylacetamide, or Dimethylformamide.

6. The temperature manipulating apparatus of claim 1, wherein the plurality of electricity conducting electrodes are positioned parallel to each other.

7. The temperature manipulating apparatus of claim 1, wherein the plurality of electricity conducting electrodes are positioned inclined to each other.

8. The temperature manipulating apparatus of claim 1, wherein the plurality of heat generating elements are in shape of strips.

9. The temperature manipulating apparatus of claim 8, wherein the strips are positioned perpendicular to the plurality of electricity conducting electrodes.

10. The temperature manipulating apparatus of claim 8, wherein the strips are positioned at an angle to the electricity conducting electrodes, wherein the angles ranges from 0 degrees to 90 degrees.

11. The temperature manipulating apparatus of claim 8, wherein the strips are of equal length and width, or unequal length and width.

12. The temperature manipulating apparatus of claim 8, wherein the strips are curved.

13. The temperature manipulating apparatus of claim 12, wherein the curvature of the strips is equal, or variable.

14. The temperature manipulating apparatus of claim 1, wherein the electrical power source is selected from an A.C. power source, a D.C. power source and a combination of an A.C. power source and a D.C. power source.

15. The temperature manipulating apparatus of claim 1, comprises a plurality of non-heat generating interspaces in between the plurality of heat generating elements.

16. The temperature manipulating apparatus of claim 1, wherein width of the plurality of heat generating elements and the plurality of non-heat generating interspaces is in ratio of between 1:1 and 3:1.

17. The temperature manipulating apparatus of claim 1, wherein the plurality of heat generating elements are positioned on the base medium by a printing process, or a lamination process.

18. A method of making a heat manipulating apparatus comprising the steps of;
providing a base medium;
positioning a plurality of heat generating elements on the base medium;
positioning a plurality of electricity conducting electrodes on the heat generating elements and the base medium, wherein the heat generating elements are connected to the electricity conducting electrodes.

19. The method of making a heat manipulating apparatus of claim 18, further comprising applying a multi-layered insulating coating with layers of a nano-thickness of less than 100 nm on the base medium.
